(19) United States
(12) Patent Application Publication
(10) Pub. No.: US 2017/0354174 A1
(43) Pub. Date: Dec. 14, 2017

(54) Popcorn Maker With Pivoting Stir Arms

(71) Applicant: Hamilton Beach Brands, Inc., Glen Allen, VA (US)

(72) Inventor: Derek A. McCullough, Richmond, VA (US)

(21) Appl. No.: 15/181,737

(22) Filed: Jun. 14, 2016

(51) Int. Cl. A23L 7/174

(52) U.S. Cl. CPC A23L 7/174; A23V 2002/00

(57) ABSTRACT

A kitchen appliance for popping popcorn comprises a heating surface capable of receiving and heating a quantity of popcorn kernels, a rotating hub projecting upward through the heating surface, and at least one stir arm pivotably coupled to the hub such that the at least one stir arm is selectively pivotable between a down position for stirring the popcorn kernels and an up position for cleaning.

### BACKGROUND OF THE DISCLOSURE

The present disclosure relates generally to a kitchen appliance for popping popcorn.

There are several different types of popcorn makers. They work by heating popcorn kernels until the kernels pop. Hot air popcorn makers blow hot air up through the kernels. Stirring popcorn makers feature a heated circular surface onto which popcorn kernels and cooking oil can be placed. They comprise a powered stirring arm to agitate the kernels while the kernels are heated. A dome-shaped cover is provided to contain the kernels as they pop. The hot air and electric popcorn poppers are popular for home use.

The stirring popcorn poppers use cooking oil, which is heated on the heating surface. The stir arm disburses and agitates the kernels during the pop cycle to prevent scorching and generally ensure uniform heating of the kernels. The oil and toppings must be cleaned off the heating surface and the stirring arm after use. However, cleaning the heating surface and stirring arm can be difficult, particularly because the close proximity between the stirring arm and the heating surface can make it difficult to clean between the stirring arm and heating surface and to clean the bottom of the stirring arm.

It has heretofore not been discovered how to create an electric popcorn popper in which the heating surface and stirring arm are easy to clean as compared to a conventional electric kettle popcorn popper.

The popcorn maker of the following disclosure accomplishes the above and other objectives and overcomes at least the above-described disadvantages of conventional popcorn poppers and methods of popping popcorn.

### BRIEF SUMMARY OF THE DISCLOSURE

Briefly stated, one aspect of the present disclosure is directed to a kitchen appliance for popping popcorn comprising a heating surface capable of receiving and heating a quantity of popcorn kernels, a rotating hub projecting upward through the heating surface, and at least one stir arm pivotably coupled to the hub such that the at least one stir arm is selectively pivotable between a down position for stirring the popcorn kernels and an up position for cleaning. In one embodiment, the stir arm is not selectively removable, which prevents a user from misplacing the component of the popcorn maker.

The at least one stir arm may comprise two stir arm segments, each stir arm segment projecting outward from opposing sides of the hub. The two stir arm segments may be joined by a center segment. The center segment may be at least partially enclosed by the hub. The center segment may be substantially horizontal. Each of the two stir arm segments may comprise an angled segment immediately adjacent the center segment. Each angled segment may be angled downward toward the heating surface when the stir arm is in the down position and angled upward away from the heating surface when the stir arm is in the up position.

At least one notch may be defined in an outer wall of the hub for engaging at least a portion of the stir arm when the stir arm is in the down position.

The at least one stir arm may be pivotably coupled to the hub with sufficient friction to enable the at least one stir arm to remain in the up position.

Another aspect of the present disclosure is directed to a method of operating a kitchen appliance comprising (a) adding a desired quantity of unpopped popcorn kernels to a heating surface of a kitchen appliance for popping popcorn; (b) activating the kitchen appliance which (i) activates a heating element disposed below the heating surface to direct heat to the heating surface, and (ii) rotates a rotating hub projecting upward through the heating surface, which in turn rotates at least one stir arm pivotably coupled to the hub; (c) waiting until a desired amount of the unpopped popcorn kernels have popped; (d) deactivating the kitchen appliance; (e) removing the popped popcorn kernels and any remaining unpopped popcorn kernels from the heating surface; and (f) pivoting the at least one stir arm from a down position for stirring the popcorn kernels to an up position for cleaning.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a perspective view of a kitchen appliance for popping popcorn, according embodiments of the present disclosure;

FIG. 2 is a perspective view of the kitchen appliance of FIG. 1, with the cover removed and the stir arm in a down position;

FIG. 3 is a perspective view of the kitchen appliance of FIG. 1, with the cover removed and the stir arm in an up position;

FIG. 4 is a close-up perspective view of the heating surface, hub, and stir arm of the kitchen appliance of FIG. 1, with the hub cap removed and the stir arm in the down position;

FIG. 5 is a close-up perspective view of the heating surface, hub, and stir arm of the kitchen appliance of FIG. 1, with the hub cap removed and the stir arm in the up position;

FIG. 6 is a bottom perspective view of the hub cap removed from the kitchen appliance of FIG. 1;

FIG. 7 is a close-up perspective sectional view of the heating surface, hub, and stir arm of the kitchen appliance of FIG. 1.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

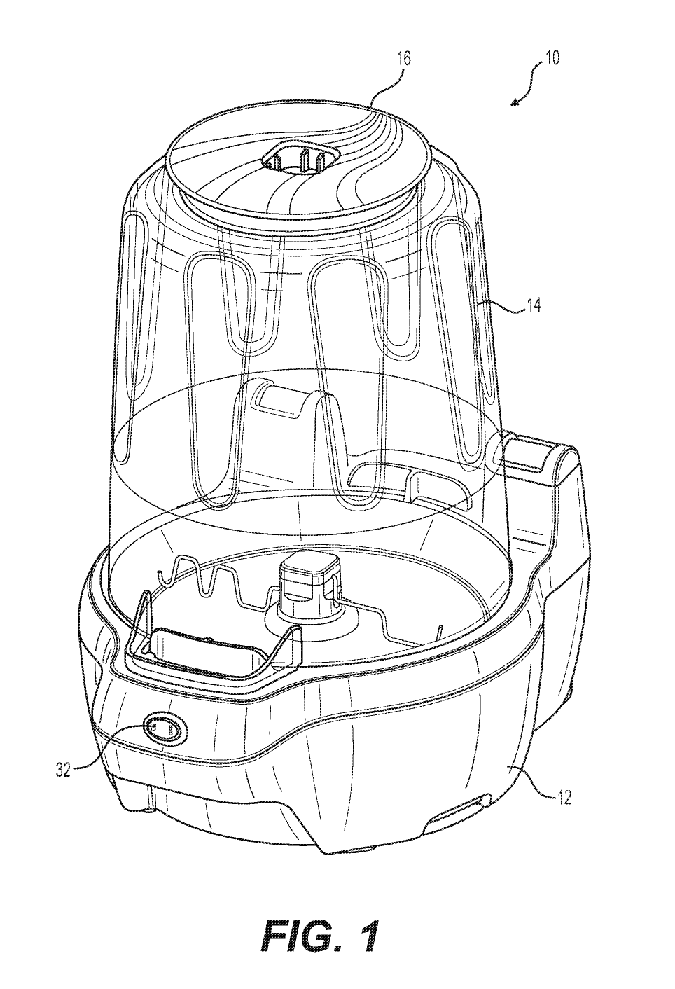

Referring to the drawings in detail, wherein like numerals indicate like elements throughout, FIGS. 1-7 illustrate a kitchen appliance 10 in accordance with a preferred embodiment of the present disclosure. The kitchen appliance 10 is intended or designed for making (“popping”) popcorn and for serving the popped popcorn.

Referring to FIGS. 1-7, the kitchen appliance 10 includes a base 12 and a removable cover 14. The cover 14 is typically, but not necessarily, transparent. The cover 14 helps retain the popcorn kernels as they pop, and can typically double as a serving bowl. The cover 14 has a lid 16 that may have an opening for adding butter and other toppings to the popped popcorn. An on/off switch 32 activates and deactivates the appliance 10.

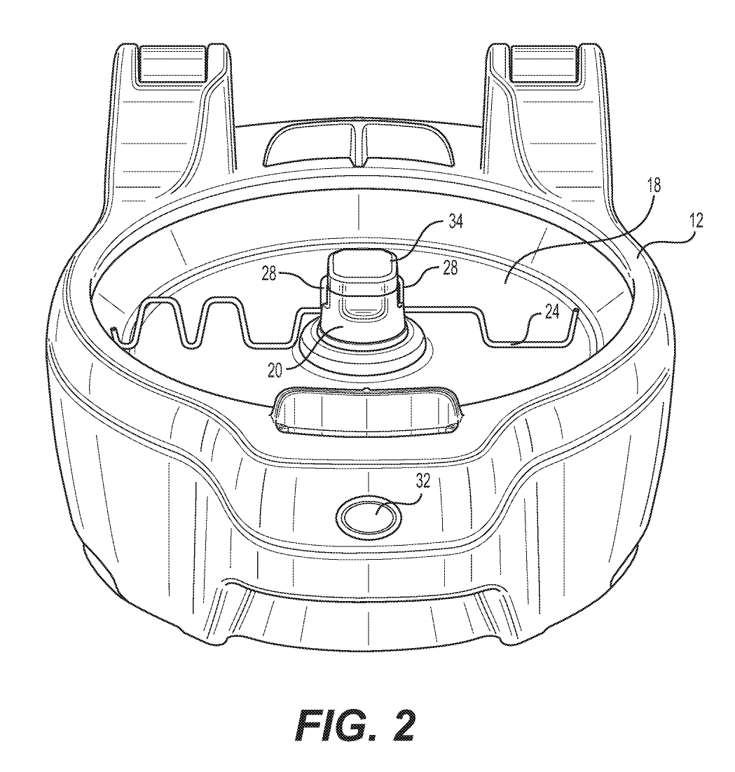

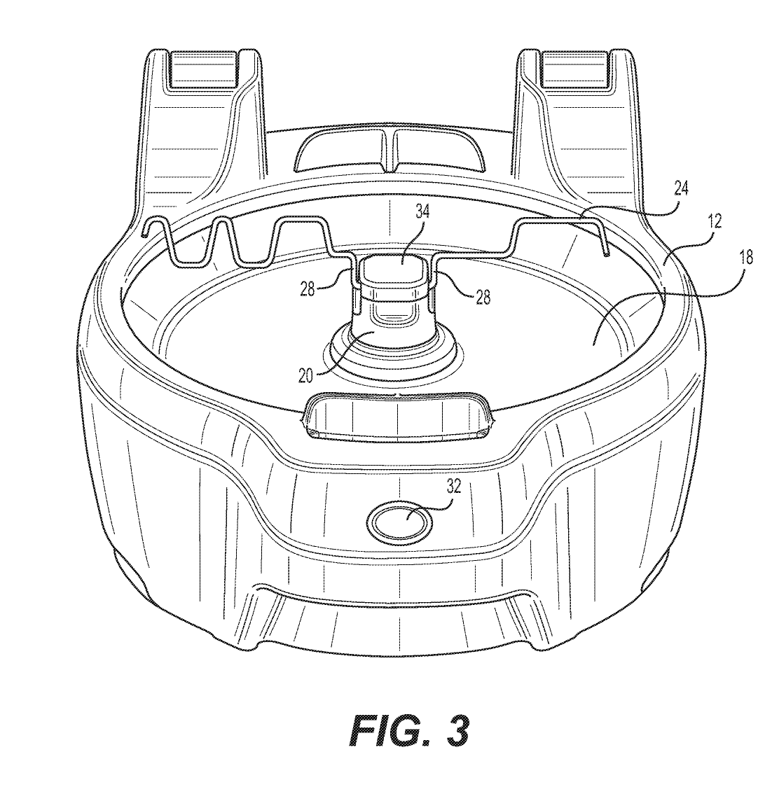

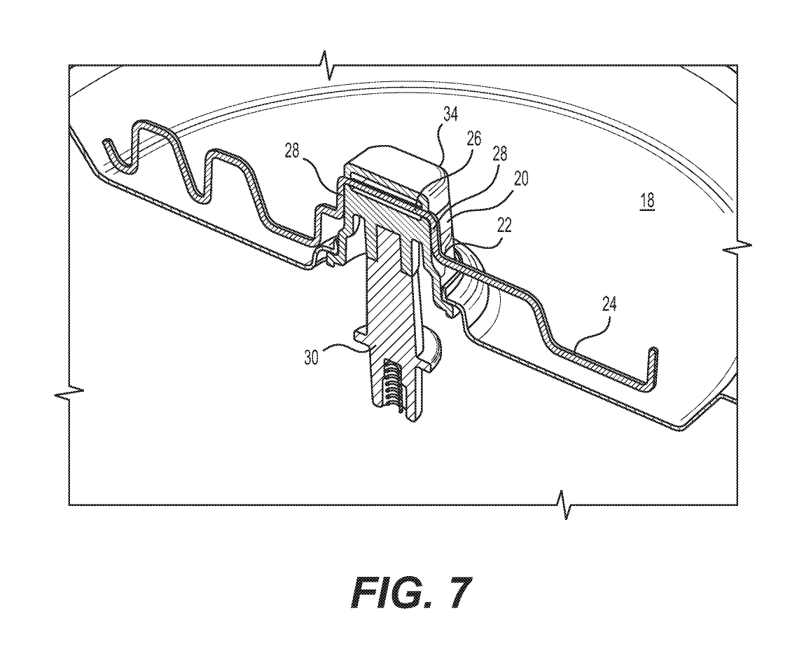

As seen in FIGS. 2 and 3, in which the cover 14 is removed, the base houses a heating surface 18. The heating surface 18 is heated by one or more heating elements (not illustrated) positioned below the heating surface 18. A rotating hub 20 projects upward through the heating surface 18. The hub 20 is coupled to an axle 30 (illustrated in FIG. 7), which in turn is coupled to a motor (not illustrated). A stir arm 24 is coupled to the hub 20. When the appliance is activated (such as via on/off switch 32), the motor is activated and rotates the axle that in turn rotates the hub 20 and the stir arm 24. The rotation of the stir arm 24 agitates the popcorn kernels as they are heated, which increases the number of kernels that pop, limits scorching of any kernels, and the like.

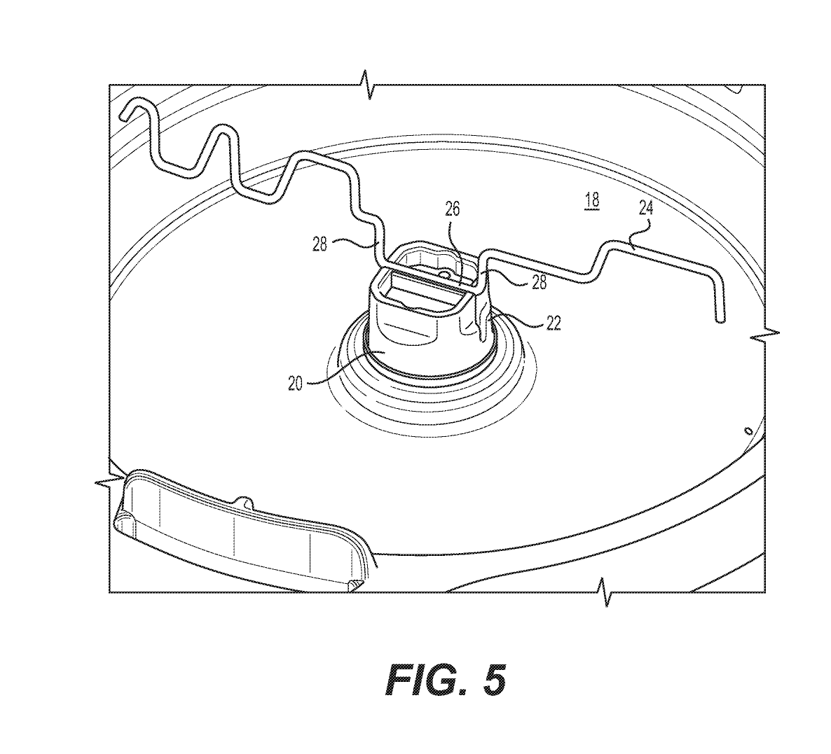

Advantageously, the stir arm 24 is pivotably coupled to the hub 20 such that the stir arm is selectively pivotable between a down position for stirring the popcorn kernels (illustrated in FIGS. 1, 2, 4, and 7) and an up position for cleaning (illustrated in FIGS. 3 and 5). Pivoting the stir arm 24 up enables a user to easily clean between the stir arm and the heating surface and all surfaces of the stir arm.

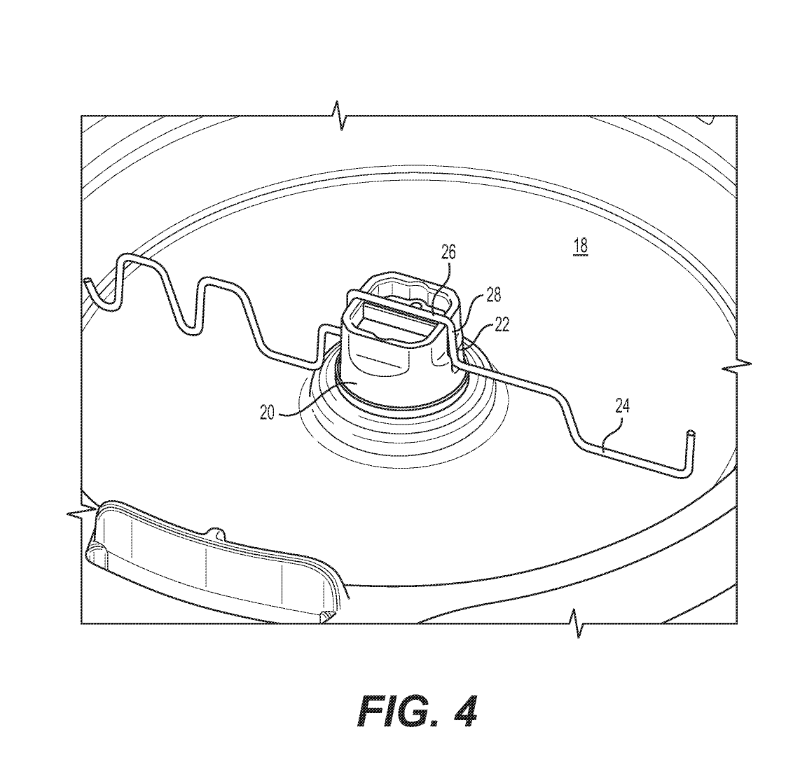

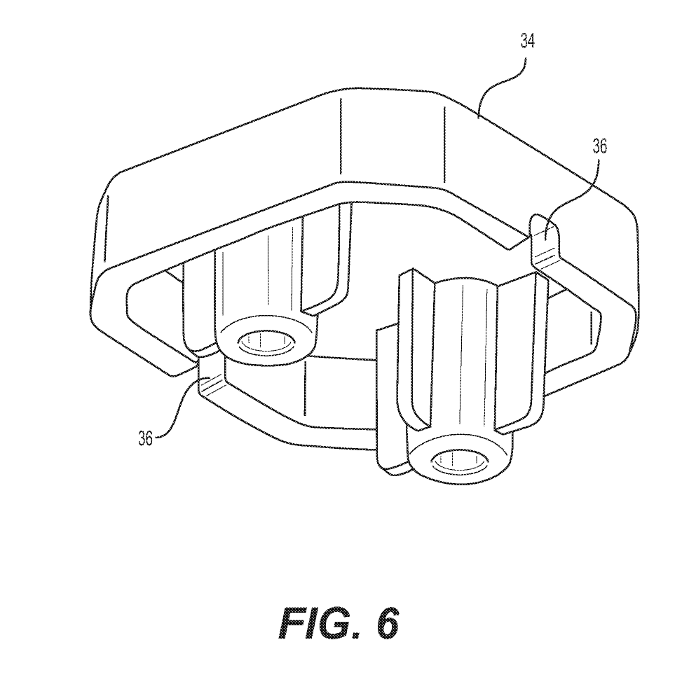

The stir arm may be pivotably coupled to the hub in any suitable arrangement. FIGS. 4-7 illustrate one such arrangement. The stir arm 24 comprises two stir arm segments, each stir arm segment projecting outward from opposing sides of the hub 20. The two stir arm segments are joined by a center segment 26. The center segment 26 may be substantially horizontal as illustrated. The hub 20 has a cap 34, which is removed in FIGS. 4 and 5 and shown separately in FIG. 6. The center segment 26 of the stir arm 24 is sandwiched between the hub cap 34 and the main body of the hub 20, such that the center segment 26 is at least partially enclosed by the hub 20. Opposing notches 36 are defined in the hub cap 34 to allow the stir arm to pass through the hub.

The cap 34 may be affixed to the hub 20 in any suitable manner. The cap 34 may be affixed such that the cap is readily removable by a user, such that the user may remove the stir arm 24 from the appliance for cleaning. However, it may not be desirable to have stir arm removable by a user, as the stir arm may be lost or damaged if removed. As such, the cap may be affixed to the hub during manufacture in a way such that the cap is not selectively or readibly removable by a user. Accordingly, the stir arm would not be removable.

The stir arm may be pivotably coupled to the hub fairly loosely such that there is minimal friction between the stir arm and the hub and/or cap. In such an arrangement, the stir arm would typically not stay in the up position for cleaning unless a user holds the stir arm in the up position. Alternatively, the stir arm may be pivotably coupled to the hub with sufficient friction between the stir arm and the hub and/or cap to enable the stir arm to remain in the up position without a user having to hold the stir arm in the up position. As an example, the size of the notches 36 may be selected to control the amount of friction. In such an embodiment in which there is sufficient friction between the stir arm and the hub and/or cap to enable the stir arm to remain in the up position, the user would typically need to move the stir arm back down to the down position after cleaning to be ready for the next use of the appliance.

The stir arm 24 comprises two angled segments 28, each immediately adjacent opposing ends of the center segment 26. The angled segments 28 angle downward toward the heating surface 18 when the stir arm 24 is in the down position and angle upward away from the heating surface 18 when the stir arm 24 is in the up position. These angled segments ensure that the stir arm is a different distances from the heating surface when the stir arm is in the two different positions (down and up). In the illustrated embodiment, the angled segments 28 are substantially vertical (i.e., perpendicular to the heating surface 18). The remainder of each of the stir arm segments project outward from the distal end of a corresponding angled segment 28.

At least one notch 22 is defined in the outer wall of the hub 20 to engage the angled segment(s) 28 of the stir arm 24 when the stir arm 24 is in the down position. Preferably, there are notches on opposing sides of the hub 20 such that both angled segments 28 are engaged by a corresponding notch 22 when the stir arm 24 is in the down position. The engagement between the angled segments 28 and the notches 22 when the stir arm 24 is in the down position helps retain the stir arm in the down position, especially during operation of the appliance. Factors such as the depth and shape of the notches 22 and/or the relative position of the angled segments 28 and the notches 22 help determine the force required to move the angled segments 28 out of and back into engagement with the notches 22 (i.e., the force required to move the stir arm out of and back into the down position). It is desirable that these factors be selected such that the stir arm stays in the down position during operation but is readily movable to the up position by a user when desired.

In operation of kitchen appliance 10, a user adds a desired quantity of unpopped popcorn kernels and cooking oil to the heating surface 18, and activates the appliance via the on/off switch 32. Activation of the appliance 10 activates a heating element (not illustrated) disposed below the heating surface 18 to direct heat to the heating surface 18 and activates a motor (not illustrated) which rotates the hub 20 and in turn the stir arm 24. The heating surface 18 heats up the oil and popcorn kernels while the rotating stir arm moves and agitates the popcorn kernels. The user waits until a desired amount of the unpopped popcorn kernels have popped, and then deactivates the appliance. The user removes the popped popcorn kernels and any remaining unpopped popcorn kernels from the heating surface 18. At some point before storing the appliance for later use, the user should clean the appliance, particularly the heating surface 18 and the stir arm 24. To help thoroughly clean the heating surface 18 and the stir arm 24, the user pivots the stir arm 24 from the down position to the up position. After cleaning, the user should return the stir arm 24 to the down position.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

We claim:

1. A kitchen appliance for popping popcorn comprising:
a heating surface capable of receiving and heating a quantity of popcorn kernels;
a rotating hub projecting upwardarly through the heating surface; and
at least one stir arm pivotably coupled to the hub such that the at least one stir arm is selectively pivotable between a down position for stirring the popcorn kernels and an up position.

2. The kitchen appliance of claim 1, wherein the at least one stir arm comprises two stir arm segments, each stir arm segment projecting outwardardly from opposing sides of the hub.

3. The kitchen appliance of claim 2, wherein the two stir arm segments are joined by a center segment.

4. The kitchen appliance of claim 3, wherein the hub further comprises a hub cap and the center segment is at least partially enclosed between the hub and hub cap.

5. The kitchen appliance of claim 4, wherein the hub cap is not selectively removable from the hub.

6. The kitchen appliance of claim 3, wherein the center segment is substantially horizontal.

7. The kitchen appliance of claim 3, wherein each of the two stir arm segments comprises an angled segment immediately adjacent the center segment, each angled segment being angled downward toward the heating surface when the stir arm is in the down position and angled upward away from the heating surface when the stir arm is in the up position.

8. The kitchen appliance of claim 1, wherein at least one notch is defined in an outer wall of the hub for engaging at least a portion of the stir arm when the stir arm is in the down position.

9. The kitchen appliance of claim 1, wherein the at least one stir arm is pivotably coupled to the hub via a friction fit to enable the at least one stir arm to automatically remain in the up position.

10. The kitchen appliance of claim 1, wherein the at least one stir arm is not removable from the hub.

11. A method of popping popcorn comprising:
(a) adding a desired quantity of unpopped popcorn kernels to a heating surface of a kitchen appliance for popping popcorn;
(b) activating the kitchen appliance which (i) activates a heating element disposed below the heating surface to direct heat to the heating surface, and (ii) rotates a rotating hub projecting upward through the heating surface, which in turn rotates at least one stir arm pivotably coupled to the hub;
(c) waiting until a desired amount of the unpopped popcorn kernels have popped;
(d) deactivating the kitchen appliance;
(e) removing the popped popcorn kernels and any remaining unpopped popcorn kernels from the heating surface; and
(f) pivoting the at least one stir arm from a down position for stirring the popcorn kernels to an up position for cleaning.

12. The method of claim 11, wherein the at least one stir arm comprises two stir arm segments, each stir arm segment projecting outward from opposing sides of the hub.

13. The method of claim 12, wherein the two stir arm segments are joined by a center segment.

14. The method of claim 13, wherein the center segment is at least partially enclosed by the hub.

15. The method of claim 13, wherein the center segment is substantially horizontal.

16. The method of claim 13, wherein each of the two stir arm segments comprises an angled segment immediately adjacent the center segment, each angled segment being angled downward toward the heating surface when the stir arm is in the down position and angled upward away from the heating surface when the stir arm is in the up position.

17. The method of claim 11, wherein at least one notch is defined in an outer wall of the hub for engaging at least a portion of the stir arm when the stir arm is in the down position.

19. The method of claim 11, wherein the at least one stir arm is pivotably coupled to the hub with sufficient friction to enable the at least one stir arm to remain in the up position.
